(19) United States
(12) Patent Application Publication
(10) Pub. No.: US 2013/0188878 A1
(43) Pub. Date: Jul. 25, 2013

(54) IMAGE ANALYSIS SYSTEMS HAVING IMAGE SHARPENING CAPABILITIES AND METHODS USING SAME

(71) Applicant: Lockheed Martin Corporation, Bethesda, MD (US)

(72) Inventor: Steve T. KACENJAR, Glenmoore, PA (US)

(73) Assignee: LOCKHEED MARTIN CORPORATION, Bethesda, MD (US)

(21) Appl. No.: 13/672,530

(22) Filed: Nov. 8, 2012

Related U.S. Application Data
(63) Continuation-in-part of application No. 13/187,447, filed on Jul. 20, 2011.
Application No. 13/187,447 is a continuation-in-part of application No. PCT/US2011/044746, filed on Jul. 20, 2011.
(60) Provisional application No. 61/557,377, filed on Nov. 8, 2011.
(60) Provisional application No. 61/434,806, filed on Jan. 20, 2011.
(60) Provisional application No. 61/365,988, filed on Jul. 20, 2010.
(60) Provisional application No. 61/434,806, filed on Jan. 20, 2011.
(60) Provisional application No. 61/365,988, filed on Jul. 20, 2010.

(51) Int. Cl. G06T 5/00

(52) U.S. Cl. CPC G06T 5/003
USPC 382/209

(57) ABSTRACT

Described herein are image analysis systems that utilize a non-linear data processing algorithm for overlaying and comparing time sequence images. The image analysis system and method also sharpens at least one of the time sequence images during the process to improve image registration accuracy.

### CROSS-REFERENCE TO RELATED APPLICATIONS

This application is related to and claims the benefit under 35 U.S.C. §119(e) of prior U.S. Provisional Patent Application 61/557,377, filed Nov. 8, 2011, which is incorporated herein by reference in its entirety. This application is also a continuation-in-part of U.S. patent application Ser. No. 13/187,447, filed Jul. 20, 2011 and which in turn claims benefit under 35 U.S.C. §119(e) of prior U.S. Provisional Patent Application 61/365,988, filed Jul. 20, 2010 and U.S. Provisional Patent Application 61/434,806, filed Jan. 20, 2011. This application is also related to PCT Application US2011/04476. This application incorporates these prior applications by reference.

### STATEMENT REGARDING FEDERALLY SPONSORED RESEARCH OR DEVELOPMENT

Not applicable.

### FIELD OF THE INVENTION

The present invention generally relates to image analysis, and, more specifically, to automated registration and analysis of time sequence images.

### BACKGROUND

A wide array of fields exist in which it can be imperative to rapidly detect and quantify changes in imagery over time. In fields such as, for example, earth remote sensing, aerospace systems and medical imaging, searching for time-dependent, regional changes of significance (e.g., material stress patterns, surface roughness, changes in inclusions and the like) across a generalized deformable surface can be complicated by extraneous factors including, for example, target movement, image acquisition device geometries, color, lighting and background clutter changes. Under these conditions and others, standard, rigid-body registration techniques often can fail to address and correct for these extraneous factors, which can prevent adequate image overlayment from be realized, thereby leading to an incorrect assessment of change over the deformable surface between time sequence images.

As used herein, a generalized deformable surface will refer to any surface that does not deform uniformly when subjected to an external or internal stress during a series of observations. In some cases, a generalized deformable surface possesses color, thermal, conductive and/or polarimetric temporal variance due to factors such as, for example, source lighting conditions and/or physical chemistry surface alterations during a series of observations. For a generalized deformable surface, application of an external or internal stress can cause the surface to deform in a non-linear fashion such that inclusions thereon can be affected in both two- and three-dimensions. That is, inclusions contained upon the generalized deformable surface may not move the same amount relative to one another when the surface is deformed and the surface's measurable contrast can vary between itself and background due to the deformation. As used herein, the term “inclusion” will refer to any spatially localized characteristic in an image that differs from image background. Illustrative examples of inclusions that can be present on a generalized deformable surface can include, without limitation, buildings, rocks, trees, fingerprints, skin pores, moles, and the like. In addition to the difficulties introduced by a deformable surface, source illumination and/or chemical changes upon the deformable surface can also result in superficial changes that can alter reflective properties that can superficially alter the appearance of the inclusions. In the most general case, both surface deformation and surface physical changes can result in superficial artifacts that are not indicative of actual changes to the inclusions. This type of non-uniform spatial movements and appearance changes can make image registration especially problematic.

The failure to adequately register images due to underlying topography changes can result in systematic errors in the quantification and classification of areas of interest in a series of time sequence images. These difficulties can be particularly magnified when multiple inclusions in a series of time sequence images all require observation. Although many automated approaches have been developed for the registration of images containing inclusions located on a rigid surface, these approaches can be much less suitable when the inclusions are located on a generalized deformable surface.

Even discounting the positioning difficulties introduced by a deformable surface, time variation of background can be a significant problem alone. For example, imprinted patterns superimposed across a deformable surface can also be spatially variable but distinct from the inclusions of interest in an image (e.g., a building complex representing an inclusion of interest can be embedded in a field of trees that is swaying in the wind, where the trees represent a time variant background that is not rigidly positioned in the image). In order to achieve effective overlay of images, an image registration process needs to be capable of handling such time variant background.

In view of the foregoing, effective systems and methods for analyzing time sequence images, particularly those containing time-variant background clutter on a generalized deformable surface, would be of significant benefit in the art. The present invention satisfies this need and provides related advantages as well.

### SUMMARY

In some embodiments, image processing devices and Data Registration Processes that perform image sharpening before conducting a two-dimensional image registration technique are described herein. In some embodiments, the image sharpening and two-dimensional image registration can occur prior to further image registration through use of a non-linear data processing algorithm.

In some embodiments, image analysis systems described herein include at least one image collection device, an image processing device operating a non-linear data processing algorithm, and at least one data output device. The image processing device is operable to overlay a test image and a reference image upon one another and perform a comparison therebetween. In some embodiments, the image processing device can further sharpen the test image and/or the reference image before overlaying.

In some embodiments, image analysis systems described herein include at least one image collection device, an image processing device operating non-linear data processing algorithm, and at least one data output device. The image processing device is operable to overlay a test image and a reference image upon one another and perform a comparison therebetween by processing both linear parameters and non-linear parameters, where each image contains a plurality of inclusions. The non-linear data processing algorithm is selected from the group including a particle swarm optimizer, a neural network, a genetic algorithm, and any combination thereof. In some embodiments, the image processing device can further sharpen the test image and/or the reference image before overlaying.

In some embodiments, methods described herein include acquiring a reference image containing a plurality of inclusions, acquiring a test image containing the plurality of inclusions, overlaying the test image upon the reference image by using a non-linear data processing algorithm, and producing an output that illustrates any differences between the test image and the reference image after overlaying takes place. In some embodiments, the methods can further include sharpening the test image and/or the reference image before overlaying takes place.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 is a schematic diagram showing the use of spatial dicing of time sequenced images to perform the data registration process, according to an example embodiment;

FIGS. 2A and 2B show illustrative images containing a plurality of mole inclusions across a patient's back taken with different camera orientations and lighting conditions, according to an example embodiment;

FIGS. 2C and 2D show illustrative images of a single mole inclusion thereon acquired with the different camera orientations and lighting conditions, according to an example embodiment;

FIG. 3 shows an illustrative flowchart demonstrating how time sequence images can be overlaid in a particular embodiment, according to an example embodiment;

FIG. 4 shows an illustrative flowchart demonstrating how time sequence images can be overlaid in another particular embodiment, according to an example embodiment;

FIGS. 5A and 5B show illustrative test and reference images of a mole inclusion before and after alignment, respectively, according to an example embodiment;

FIG. 5C shows an illustrative difference image of the misaligned images in FIG. 5A, according to an example embodiment;

FIG. 5D shows an illustrative difference image of the aligned images in FIG. 5B, according to an example embodiment; and

FIG. 6A shows an illustrative 4D scatter plot of mapping coefficients for four parameters (translation, rotation, magnification and background color) before processing with a particle swarm optimizer, according to an example embodiment;

FIGS. 6B-6D show illustrative 2D scatter plots of rotation, magnification and translation parameters before processing with a particle swarm optimizer, according to an example embodiment;

FIGS. 6E-6H show illustrative plots corresponding to those of FIGS. 6A-6D, illustrating the convergence of mapping coefficients after processing with the particle swarm optimizer, according to an example embodiment.

FIG. 7 is a schematic of an image registration process includes at least an Image Preprocessing (IP) block and the second building block is a Registration Method (RM) block, according to an example embodiment.

FIG. 8 shows a diagrammatic representation of a computing device for a machine in the example electronic form of a computer system 2000, according to an example embodiment.

### DETAILED DESCRIPTION

The present disclosure is directed, in part, to image analysis systems that utilize a non-linear data processing algorithm to detect and characterize changes between time sequence images. The present disclosure is also directed, in part, to methods for analyzing time sequence images, including those having time-variant background clutter, using a non-linear data processing algorithm. The image analysis systems and methods for analyzing time sequence images can further utilize sharpening of the time sequence images to improve the analysis.

Current image registration techniques often utilize a variety of two-dimensional image correlation methods. Normally, a test image and a reference image are not pre-processed prior to applying these two-dimensional image correlation methods. As set forth herein, it has been surprisingly discovered that through sharpening of time sequence images prior to performing image registration, the resulting registration accuracy can be improved and possibly significantly improved.

In some embodiments, image sharpening can be performed prior to performing two-dimensional image registration. In some embodiments, image sharpening can be performed prior to performing image registration using a non-linear data processing algorithm. Illustrative systems and methods utilizing non-linear data processing algorithms are set forth in U.S. patent application Ser. No. 13/187,447, filed Jul. 20, 2011. By applying initial image sharpening techniques, a better initial solution of the image overlay can be obtained prior to applying non-linear data processing techniques.

As used herein, the term “parameters” will refer to the input of the image analysis system. As used herein, the term “mapping coefficients” will refer to one of the outputs of the image analysis system. In some cases, the initial mapping coefficients determined from processing of linear parameters can be fed into a non-linear data processing algorithm as initial estimated parameters of an inclusion's location. For example, estimated parameters of an inclusion's location can be determined from an initial coarse alignment based upon rigid body alignment techniques (e.g., using two-dimensional image correlation techniques). Using the estimated solution of an inclusion's location can advantageously provide a more rapid convergence of the non-linear data processing algorithm in determining finalized mapping coefficients. Mapping coefficients can include the transformation coefficients that minimize differences across a reference image and a test image that result from geometric alterations and surface reflective properties.

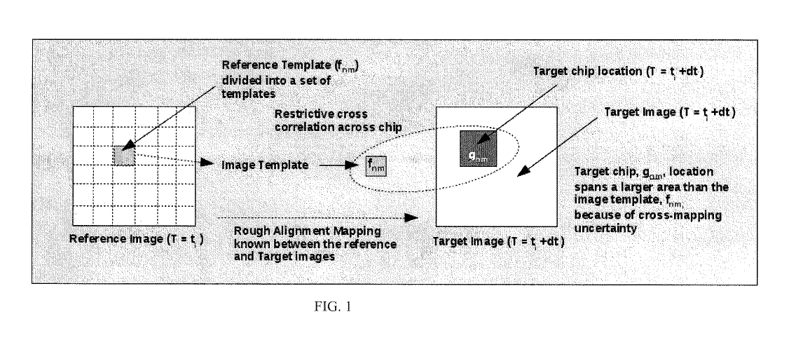

FIG. 1 is a schematic diagram showing the use of spatial dicing of time sequenced images to perform the data registration process, according to an example embodiment. FIG. 1 can also be thought of as a template-based correlation process. The use of spatial dicing of time sequenced images plays a role in the effectiveness of performing the data registration process. Spatial gridding can alleviate non-linear processing constraints by minimizing the number of degrees of freedom that characterizes local deformation across the gridded area. The depiction of this approach is shown in FIG. 1 and assumes that the target gridded area is larger than a roughly positioned reference area. Local discrete image correlation methods can then be used to provide first-order translational correction. Such an operation can serve as a pre-processing step in later gridded iterative operations to correct for higher order deformations such as but not limited to magnification and rotation.

Other methods for regional area selection other than spatial gridding can also be considered to minimize the magnitude of higher-order correction when registering the time sequenced images. For example, but not limited to, user-defined pre-selected skin lesions may need repeated viewing over time. In this case, the lesion itself serves as the sample point where a gridded area is applied.

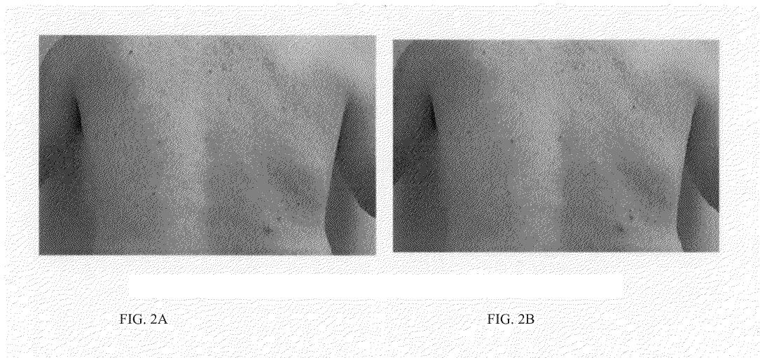

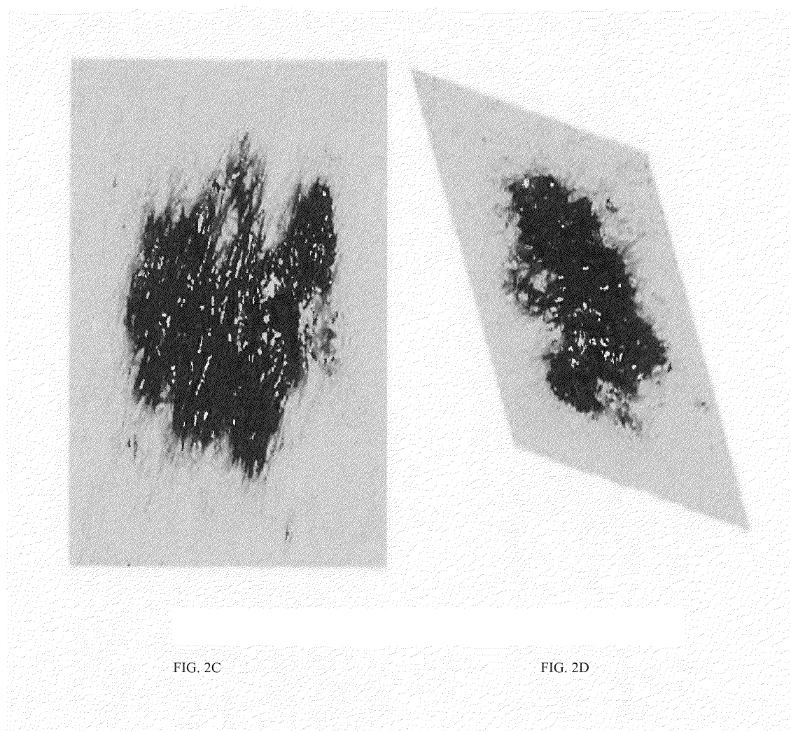

As noted previously, the overlay and analysis of time sequence images can be complicated by both linear and non-linear geometric effects and imaging conditions, as well as time-variant background clutter. Time-variant background clutter can arise from the surface being imaged and/or from sensor noise within an image collection device being used for detection, for example. As a non-limiting example, body hair and varying skin pigmentation can complicate the registration of skin images. In addition to translational and rotational misalignment, image parameters such as, for example, differing camera angles, lighting, magnification and the like can complicate an image overlay and registration process. These issues can be further exacerbated on a deformable surface where the positions of inclusions relative to one another can change in a non-linear fashion due to variable surface deformation. As a non-limiting example of the differences that can be observed in images acquired at different times, FIGS. 2A and 2B show illustrative images containing a plurality of mole inclusions across a patient's back taken with different camera orientations and lighting conditions, and FIGS. 2C and 2D show illustrative images of a single mole inclusion thereon acquired with the different camera orientations and lighting conditions. As illustrated in FIGS. 2A-2D, the issues associated with the misalignment of multiple inclusions (moles) can be a particularly daunting, given the number of inclusions involved and their non-uniform degree of deformation in a series of images.

When the number of inclusions in a series of time sequence images is small, conventional methods such as, for example, point-and-stare or manual overlay can be adequate. In such cases, image overlay can be performed by individually translating and rotating images of each inclusion and either manually or electronically overlaying the images. However, as the number of inclusions and images increases, this approach can become time and cost prohibitive. Such overlay processes can also fail to take into account non-linear image parameters. Illustrative non-linear image parameters can include but are not limited to, for example, image collection device rotation and tilt (e.g., image collection device shear), lighting, magnification, image tone, image gain, time-variant background changes, and the like. For example, when imaging the skin, musculature changes, subtle differences in patient positioning and other variables can result in local distortions within an image as a result of the impact of these non-linear parameters. These factors are not generally addressed by simple linear-based image overlay and registration techniques, which fail to take into account local rotation and image magnification differences, for example. Furthermore, generalized non-linear regression-based models can be too computationally intensive to provide near real-time image assessment or to provide the robustness needed to address time-variant background clutter. The systems and methods described herein can advantageously address these shortcomings by first providing an estimated linear overlay, followed by a non-linear overlay to achieve a more accurate image registration and analysis. Still further, the present systems and methods can allow for enhanced detection of morphological changes that may not be evident when using conventional linear processing techniques.

As a further advantage of the present systems and methods, both single modality image collection devices and multiple modality image collection devices can be used. In the cases of a multiple modality system, at least two different types of image collection devices can be used to investigate different attributes of inclusions located within an image. For example, time sequence visual images can be superimposed with time sequence thermal images, polarimetric images, radiographic images, magnetic images, and/or the like in order to develop a more effective and informative inclusion overlay. For example, in the case of a single modality image collection device, changes in an inclusion can be characterized in terms of regional size differences, color differences, asymmetry changes, and boundary changes, for example. In a multiple modality image collection device, these changes can be further augmented with changes such as, for example, density differences, chemical differences, magnetic differences, and/or polarimetric differences. In some cases, one such attribute can be essentially fixed in an image, such that an inclusion being imaged can be oriented with respect to the fixed point (e.g., another inclusion that does not change), thereby constituting a geographical information system (GIS).

There are a number of fields in which the present image analysis systems and related methods can find particular utility. In particular, the present image analysis systems and methods can be especially useful in fields including, for example, medical imaging, structural fatigue monitoring, satellite imaging, geological testing and surface chemistry monitoring. It should be recognized that images obtained in these fields and others can have inclusions located upon a deformable surface. In the field of medical imaging, the skin and underlying tissue can exhibit differential elasticity (e.g., due to weight gain or loss or a change in musculature) and make its surface spatially deformable. In addition, changing skin pigmentation and hair covering can represent time-variant background clutter that can complicate the overlay of skin images. In the fields of satellite imaging and geological testing, the earth's surface can similarly be considered to be deformable. Likewise, a bendable surface (e.g., an airplane wing or a structural support) can at first glance appear to be substantially rigid but instead be deformable to such a degree that the relative positions of inclusions thereon (e.g., rivets) can change over time. In an embodiment, the change in relative positions of inclusions located on a bendable surface can be used as a means to gauge structural fatigue. Although the present invention has been described to have utility in the foregoing fields, it should be recognized that these fields have been presented for illustration purposes only and should not be considered limiting. In general, the present image analysis systems and methods can be applied to analysis of time sequence images of any application type, particularly those containing inclusions located upon a deformable surface.

The morphological classification of skin lesions (“moles”) and monitoring them over time is important for the detection of melanoma and other types of skin cancer. When used for medical imaging, the present image analysis systems and methods can be particularly advantageous for these types of dermatology applications. In particular, observation of changes in the color, shape and size of moles over time can lead to the early detection of skin cancer while it is still readily treatable. Although observation can be performed visually by a dermatologist or through patient self-observation, typical patients have several hundred moles, all of which need to be monitored over time, which can complicate visual inspection efforts. In addition, by the time a change to a mole becomes visible to the naked eye, a skin cancer may have already metastasized beyond its point of origin and become much more difficult to treat. In addition to skin cancer monitoring, the present image analysis systems and methods can also be used for monitoring other skin conditions including, for example, rashes, burns and healing. In this regard, fixed inclusions such as, for example, skin pores can be utilized as fixed reference points that do not substantially change during the course of acquiring time sequence images.

In the dermatology field, it is imperative to identify potentially hazardous skin lesions as early as possible. Methods presently in use by dermatologists typically do not allow identification and analysis of skin lesions that are smaller about than 4 mm in size, when they are at their least harmful. The criticality of early detection is emphasized in the fact that penetration depth of a melanoma (i.e., the Breslow thickness) directly correlates with the likelihood of metastasis and therefore patient survivability. As shown in Table 1 below, early detection of small skin lesions is critical in order to achieve maximum patient survival rates.

TABLE 1

| Breslow Thickness (mm) | Approximate Survival Rate |
|---|---|
| <1 | 95%-100% |
| 1-2 | 80%-96% |
| 2-4 | 60%-75% |
| >4 | 50% |

Like the skin, other bodily tissues and cavities can be considered to have a deformable surface. In this regard, the present image analysis systems and methods can also be extended to subsurface imaging such as, for example, breast mammography and internal imaging such as, for example, colon, stomach, esophageal and lung imaging. It should be noted that the present image analysis systems and methods are not limited to visual images, particularly in the medical field. Particularly, overlay and comparison of images such as, for example, PET, SPECT, X-RAY, CT, CAT, MRI and other like images can be accomplished with the present image analysis systems and methods. Appropriate imaging protocols using these imaging techniques will be followed and used.

In the embodiments described herein, it is to be recognized that various blocks, modules, elements, components, methods and algorithms can be implemented through using computer hardware, software and combinations thereof. To illustrate this interchangeability of hardware and software, various illustrative blocks, modules, elements, components, methods and algorithms have been described generally in terms of their functionality. Whether such functionality is implemented as hardware or software will depend upon the particular application and any imposed design constraints. For at least this reason, one can implement the described functionality in a variety of ways for a particular application. Further, various components and blocks can be arranged in a different order or partitioned differently, for example, without departing from the spirit and scope of the embodiments expressly described.

Computer hardware used to implement the various illustrative blocks, modules, elements, components, methods and algorithms described herein can include a processor configured to execute one or more sequences of instructions, programming or code stored on a readable medium. The processor can be, for example, a general purpose microprocessor, a microcontroller, a graphical processing unit, a digital signal processor, an application specific integrated circuit, a field programmable gate array, a programmable logic device, a controller, a state machine, a gated logic, discrete hardware components, or any like suitable entity that can perform calculations or other manipulations of data. In some embodiments, computer hardware can further include elements such as, for example, a memory [e.g., random access memory (RAM), flash memory, read only memory (ROM), programmable read only memory (PROM), erasable PROM], registers, hard disks, removable disks, CD-ROMS, DVDs, or any other like suitable storage device.

FIG. 8 shows a diagrammatic representation of a computing device for a machine in the example electronic form of a computer system 2000, within which a set of instructions for causing the machine to perform any one or more of the comparisons or correction methodologies discussed herein can be executed or is adapted to include the apparatus for the comparisons or correction methodologies as described herein. In various example embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a personal computer (PC), a tablet PC, a set-top box (STB), a Personal Digital Assistant (PDA), a cellular telephone, a portable music player (e.g., a portable hard drive audio device such as a Moving Picture Experts Group Audio Layer 3 (MP3) player, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor or multiple processors 2002 (e.g., a central processing unit (CPU), a graphics processing unit (GPU), arithmetic logic unit or all), and a main memory 2004 and a static memory 2006, which communicate with each other via a bus 2008. The computer system 2000 can further include a video display unit 2010 (e.g., a liquid crystal display (LCD) or a cathode ray tube (CRT)). The computer system 2000 also includes an alphanumeric input device 2012 (e.g., a keyboard), a cursor control device 2014 (e.g., a mouse), a disk drive unit 2016, a signal generation device 2018 (e.g., a speaker) and a network interface device 2020.

The disk drive unit 2016 includes a computer-readable medium 2022 on which is stored one or more sets of instructions and data structures (e.g., instructions 2024) embodying or utilized by any one or more of the methodologies or functions described herein. The instructions 2024 can also reside, completely or at least partially, within the main memory 2004 and/or within the processors 2002 during execution thereof by the computer system 2000. The main memory 2004 and the processors 2002 also constitute machine-readable media.

The instructions 2024 can further be transmitted or received over a network 2026 via the network interface device 2020 utilizing any one of a number of well-known transfer protocols (e.g., Hyper Text Transfer Protocol (HTTP), CAN, Serial, or Modbus).

While the computer-readable medium 2022 is shown in an example embodiment to be a single medium, the term “computer-readable medium” should be taken to include a single medium or multiple media (e.g., a centralized or distributed database, and/or associated caches and servers) that store the one or more sets of instructions and provide the instructions in a computer readable form. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, tangible forms and signals that can be read or sensed by a computer. Such media can also include, without limitation, hard disks, floppy disks, flash memory cards, digital video disks, random access memory (RAMs), read only memory (ROMs), and the like.

The non-linear data processing algorithms and other executable sequences described herein can be implemented with one or more sequences of code contained in a memory. In some embodiments, such code can be read into the memory from another machine-readable medium. Execution of the sequences of instructions contained in the memory can cause a processor to perform the process steps described herein. One or more processors in a multi-processing arrangement can also be employed to execute instruction sequences in the memory. In addition, hard-wired circuitry can be used in place of or in combination with software instructions to implement various embodiments described herein. Thus, the present embodiments are not limited to any specific combination of hardware and software. When a generalized machine executes a set of instructions in the form of non-transitory signals, the generalized machine generally is transformed into a specialized machine having a specific purpose and function.

As used herein, a machine-readable medium will refer to any medium that directly or indirectly provides instructions to a processor for execution. A machine-readable medium can take on many forms including, for example, non-volatile media, volatile media, and transmission media. Non-volatile media can include, for example, optical and magnetic disks. Volatile media can include, for example, dynamic memory. Transmission media can include, for example, coaxial cables, wire, fiber optics, and wires that form a bus. Common forms of machine-readable media can include, for example, floppy disks, flexible disks, hard disks, magnetic tapes, other like magnetic media, CD-ROMs, DVDs, other like optical media, punch cards, paper tapes and like physical media with patterned holes, RAM, ROM, PROM, EPROM and flash EPROM.

In some embodiments, image analysis systems described herein include at least one image collection device, an image processing device operating a non-linear data processing algorithm, and at least one data output device. The image processing device is operable to overlay a test image and a reference image upon one another and perform a comparison there between.

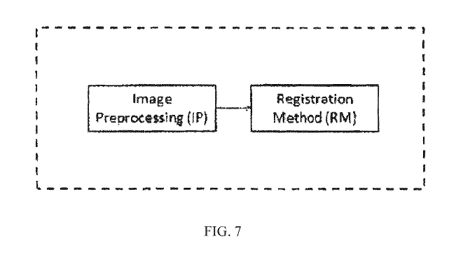

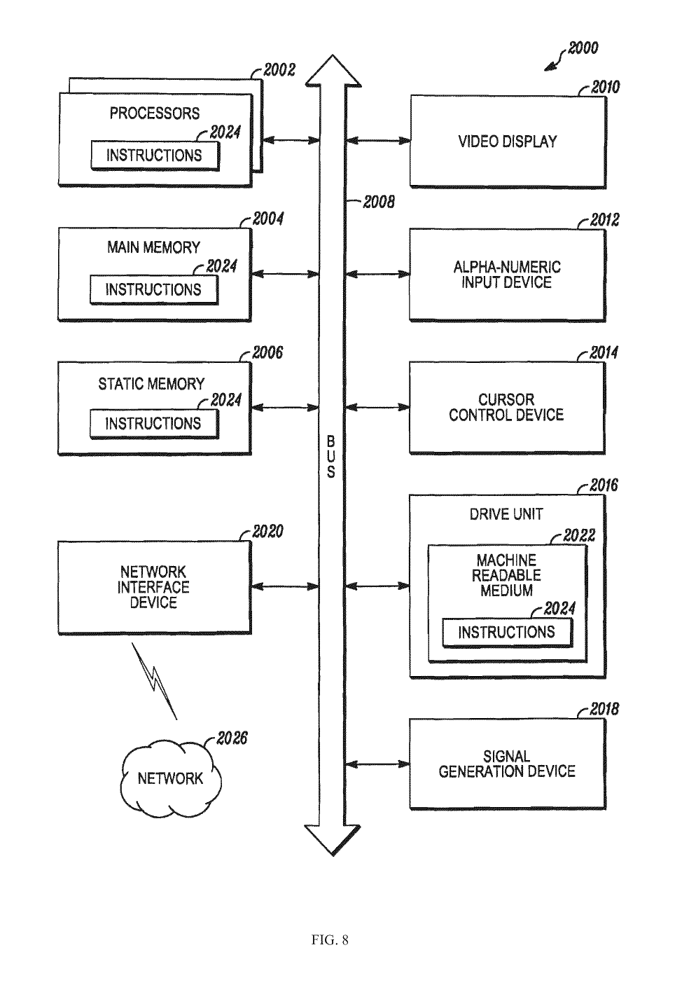

Now referring to FIG. 7, an image registration process includes at least two building blocks. The building blocks are typically implemented in software, hardware or a combination of the two. The first building block is an Image Preprocessing (IP) block 710 and the second building block is a Registration Method (RM) block. As used herein, a “nonlinear data processing (NDP) algorithm” will refer to a class of methods where image registration is performed when either the IP or RM blocks or both blocks in the process change has nonlinear processing elements. For example, non-linear IP can include but is not limited to image sharpening and intensity thresholding methods. In addition, linear image scaling followed by a non-linear registration processes such as with the use of PSO methods, also results in a nonlinear data process algorithm during the image registration process. It should be noted that in a data registration process, such as the one shown in FIG. 7, if either IP or MR or both relate to a non-linear process, the entire image registration process is referred to as a non-linear data registration process.

As used herein, a “non-linear data processing algorithm” will refer to a class of algorithms for characterizing a geometric transformation used in overlaying two or more images that contain inclusions, particularly images that have a changing background and are subject to surface deformation. In some cases, a non-linear data processing algorithm can utilize parameters that are not described by the inclusions' translational or rotational coordinates (e.g., spectral, thermal, radiographic, magnetic, polarimetric parameters, and/or the like). Such geometric transformations can include both linear translational mappings as well as higher-order mappings such as, for example, image rotation, shear, magnification and the like. In addition, the non-linear data processing algorithm can provide image background normalization coefficient estimates to address reflective and color differences between the test image and the reference image. Still further, the non-linear data processing algorithm can include various pre-processing operations that can be performed prior to performing the geometric transformation. Illustrative pre-processing operations can include, for example, morphological filtering of the image and spatial image sharpening. In some embodiments, the images can be subdivided into a plurality of sectors prior to applying the non-linear data processing algorithm.

Illustrative non-linear data processing algorithms can include, for example, particle swarm optimizers, neural networks, genetic algorithms, unsharp masking, image segmentation, morphological filtering and any combination thereof. Although certain details in the description that follows are directed to particle swarm optimizers, it is to be recognized that a particle swarm optimizer can be replaced by or used in combination with any suitable non-linear data processing algorithm, including those set forth above.

In some embodiments, the non-linear data processing algorithm can be a particle swarm optimizer. In brief, particle swarm optimization is a computational technique that optimizes a problem by iteratively seeking to improve upon a candidate solution with regard to a given measure of quality. Particle swarm optimization techniques involve moving a population of particles (e.g., inclusions, which are state vectors, that are described by various parameters being fed into a model) toward a candidate solution for each particle according to simple mathematical formulas relating to the state vector for each particle within a state space. As used herein, a “state vector” will describe a potential candidate solution for a set of input parameters (both linear parameters and non-linear parameters) that minimizes differences between a reference image and a test image. For example, if the differences between a reference image and a test image are only associated with rotation and magnification differences, then a two-parameter state vector can be used to describe each particle in a particle swarm. Related two-dimensional state spaces and higher order state spaces are also contemplated by the embodiments described herein.

Each particle of a particle swarm has a unique location that corresponds to unique rotation and magnification parameters, for example, in an illustrative two-dimensional state space. As the particles travel through this two-dimensional state space, the parameters can be used to distort the test image, which can then be compared to the reference image. In an embodiment, distortion of the test image can take place by mapping each pixel from the original target space into new locations and then performing a re-sampling of the distorted image to check for convergence. This comparison can take on several different forms such as, for example, an objective function used by the particle swarm optimizer (e.g., differential entropy, Hamming distance, and/or the like). After a comparison has been performed, some particles can have a location in the transformed image that better matches the reference image. In a particle swarm optimization process, a particle's movement is influenced by its best known local position, which is influenced by the value of the objective function that is computed during a particular iteration. Each particle is also guided toward the best known positions in the state space, which are continually updated as better positions are found by other particles. That is, the iteratively determined location for a given particle is influenced by (1) its position that gives its minimum objective function value during any previous iteration and (2) the optimal position identified by the particle swarm as provided by the minimization of objective function values across the entire particle swarm. Each iteration is expected to move the particle swarm toward the best global solution for the particle positions. This process can be generalized to as many parameters as required to minimize mapping differences.

A particle swarm optimizer can be an especially useful non-linear data processing algorithm for addressing the time-changing environment across image pairs. The presence of inclusions and background features can be simultaneously evaluated, since each pixel of the test image and the reference image can be compared. As the test image is deformed by each particle of the swarm, an objective function can be computed and recorded. In general, the inclusions form a fixed reference over which the objective function can be minimized as the particle swarm evolves. The time-variant background can convey random noise to the measurement of the objective function, which can be addressed through successive iterations that converge toward the mapping coefficients of the inclusions of interest within the images.

In various embodiments, the present image processing systems and methods can detect changes in the shape, size and boundary conditions for a plurality of inclusions over a period of time. In various embodiments, detection of such changes can involve acquisition of a reference image and then acquisition of at least one test image at a later time. In some embodiments, an initial coarse alignment of the plurality of inclusions in the test image can be performed upon the plurality of inclusions in the reference image (e.g., using two-dimensional image correlation techniques). By performing an initial coarse alignment of the plurality of inclusions, a more rapid convergence of the non-linear data processing algorithm can be realized when aligning the inclusions. In some embodiments, coarse alignment can be performed manually. In other embodiments, a hybrid landmark/intensity-based registration method can be used to identify tie-points across each image in order to perform coarse alignment. For example, invariant inclusions on the surface being imaged can be established as markers for performing image alignment. In some embodiments, an optical matched filter can be used in performing the coarse alignment. It should be noted that in the embodiments described herein, the inclusions in the reference image are held fixed, while the inclusions in the test image are transformed to their optimized positions using the non-linear data processing algorithm.

In some embodiments, initial coarse alignment of a test image and a reference image can take place using a two-dimensional correlation technique. Illustrative two-dimensional correlation techniques can include, for example, cross correlation, sum of absolute difference correlation, sum squared distance cross correlation, and normalized cross correlation. Other two-dimensional correlation techniques are also envisioned. Additional details regarding the above two-dimensional correlation techniques can be found in the Appendix I of the disclosure. In some embodiments, these two-dimensional correlation techniques can be applied prior to performing a non-linear data processing algorithm. In some embodiments, sharpening of a test image and/or a reference image can take place prior to applying the two-dimensional correlation technique.

Image sharpening can take place by any technique. In some embodiments, a 2-pixel image sharpening technique can be applied. In some embodiments, an unsharp masking filter can be applied after image sharpening.

In some embodiments, an Affine transformation or a Perspective transformation (i.e., a generalized three-dimensional transformation) can be used during or subsequent to utilizing the non-linear data processing algorithm. In some embodiments, higher order model generalizations can be used in overlaying a test image upon a reference image. The foregoing transformations can account for non-linear parameters in a test image and a reference image and allow sectors of the test image to be deformed onto the reference image, as described in more detail below. An Affine transformation involves a geometric spatial transformation (e.g., rotation, scaling, and/or shear) and a translation (movement) of an inclusion Likewise, a generalized Perspective transformation can be used to handle higher dimensional surface topographies.

In some embodiments, the image processing device can be operable for subdividing each image into a plurality of sectors and determining a set of mapping coefficients for each of the plurality of sectors. In some embodiments, the image processing device can be operable to deform each sector in the test image onto a corresponding sector in the reference image, after determining the set of mapping coefficients for each sector, thereby overlaying the inclusions therein. By deforming each sector in a test image onto a corresponding sector in a reference image, inclusions therein can be overlaid and compared for differences according to some embodiments.

In some embodiments, the image processing device can process both linear parameters and non-linear parameters in overlaying the test image and the reference image. In some embodiments, the image processing device can be operable to determine morphological changes that occur in inclusions in the test image relative to the reference image. In some embodiments, these changes can be listed as a signature vector for the inclusions. Attributes of the signature vector can include, for example, changes in aerial size, inclusion spatial asymmetry, inclusion boundary characterization, color changes, and the like. In some embodiments, the image processing device can be operable to provide visual depictions of each element of the signature vectors or combined depictions of the elements of the signature vectors as Geographical Information System (GIS) information maps that depict the type and magnitude of changes that exist across each inclusion.

As used herein, “linear parameters” are the modeling coefficients that describe the linear translation between a test image and a reference image. Linear parameters include vector quantities that describe an inclusion's real position in three-dimensional space, particularly x-, y- and z-coordinates. As used herein, “non-linear parameters” are the modeling parameters used in the non-linear data processing algorithm, including, for example, rotation, magnification, shear and the like. Collectively, the linear parameters and the non-linear parameters can alter the apparent real position or appearance of an inclusion in two- and three-dimensional space.

In some embodiments, the image processing device can process the linear parameters prior to processing the non-linear parameters. In general, the linear parameters of the state vector are easier to address computationally and can be used to achieve a better initial solution for the position of each inclusion. The initial solution can be fed into the non-linear data processing algorithm when the non-linear parameters are processed. Subsequently, the non-linear parameters can be processed to “fine tune” the optimal linear position for the mapping of sectors in the test image onto corresponding sectors in the reference image. This can provide an enhanced non-linear correction. In some embodiments, both the linear parameters and the non-linear parameters can be processed in each iteration of the non-linear data processing algorithm. In some embodiments, the linear parameters can be processed separately prior to using the non-linear data processing algorithm. In other embodiments, only the linear parameters are processed initially by the non-linear data processing algorithm, and the non-linear parameters are temporarily ignored. In such embodiments, after a desired degree of convergence for the inclusions' positions has been reached (e.g., when the differential entropy between sectors of the reference image and the test image has been minimized), the non-linear parameters can be processed separately or in combination with the linear parameters. Such initial processing of the linear parameters can advantageously increase processing speed. In still other embodiments, the non-linear parameters can be initially processed by a processing algorithm that is separate from the non-linear data processing algorithm, before an initial solution for the inclusions' positions is fed into the non-linear data processing algorithm. In some embodiments, the images can be sharpened prior to processing of the linear parameters and the non-linear parameters.

In some embodiments, only the non-linear parameters are processed using the non-linear data processing algorithm. When translating and aligning sectors in a test image upon corresponding sectors in a reference image, linear parameters can many times be effectively addressed through standard image processing techniques, as noted above. However, such standard techniques can be inefficient when addressing the non-linear parameters related to the images. As previously described, the non-linear data processing algorithms used in the present embodiments can be particularly adept at addressing the non-linear parameters associated with the geometric transformation used in the non-linear data processing algorithm. In addition, by having the non-linear data processing algorithms use linear estimates for each sector, more rapid convergence of the non-linear data processing algorithm can be realized when the non-linear parameters are processed. In some embodiments, the convergence rate can nearly double by having the non-linear data processing algorithm process only the non-linear parameters. In some embodiments, the increase in convergence rate can be even greater.

In some embodiments, overlay of the test image and the reference image can be iteratively performed for a fixed number of cycles. In other embodiments, overlay of the test image and the reference image can be iteratively performed using the non-linear data processing algorithm until a desired degree of convergence is reached through optimization. In some embodiments, convergence can be determined when an objective function within the test image is minimized or a difference of the objective function is minimized between iterations. That is, in such embodiments, convergence can be determined when the error (as measured by the change in objective function between iterations) between the test image and the reference image is minimized. Illustrative objective functions can include, for example, image entropy, hamming distance, gray level per band, mutual information estimation, and any combination thereof. In some embodiments, the non-linear data processing algorithm can be used to find a global minimum across each sector by adjusting the mapping coefficients. Once the optimal values for the mapping coefficients have been determined, any remaining differences can be characterized in terms of morphological changes in the inclusions within an image or due to residual alignment error. The inclusion of non-linear parameters advantageously can provide better registration and change sensitivity detection between corresponding sectors within a test image and a reference image. When only linear parameters are processed to affect registration, higher levels of systematic errors can be introduced.

In some embodiments, processing can be performed until mapping coefficient estimates and/or objective function estimates in successive iterations differ by less than a user defined value. It is to be recognized that a desired degree of convergence will vary depending upon the intended application in which the image analysis system is used. Some applications may require a tighter convergence, while others will require less.

When using an entropy differencing approach in the non-linear data processing algorithm, subtracting corresponding sectors from the test image and the reference image can provide information on the differential entropy between them and provide a measure of the goodness of overlay agreement when the mapping coefficients are adjusted. In some embodiments, the sectors in the test image and the reference image are substantially identical in size. In other embodiments, the sectors in the test image can be larger than the sectors in the reference image. Advantages of making the sectors in the test image larger can include allowing any residual error in sector positions remaining after the linear parameters are initially processed to be adequately compensated for when the non-linear parameters are processed using the non-linear data processing algorithm. When there is a perfect overlay between corresponding sectors within a test image and a reference image, the entropy difference is zero. After an optimal overlay has been achieved, any non-zero entropy difference either represents morphological changes in the inclusion(s) over time or residual alignment error from the non-linear data processing algorithm.

Once a satisfactory overlay of the test image and the reference image has been achieved, standard image change comparison methods can then be performed. In some embodiments, the image processing device is operable to determine any differences between the test image and the reference image for each inclusion after the overlay has been performed. In alternative embodiments, image comparison on an inclusion-by-inclusion basis can be performed by visual inspection after the overlay has been performed. In some embodiments, image comparison can be performed by the image processing device (e.g., a computer or graphical processing unit) on a regional- or pixel-based basis. In this regard, factors that can influence the overlay efficiency and the accurate determination of a difference output include, for example, the ability to correct for global or local background alterations and local surface deformation about each inclusion.

It is to be recognized that, in some embodiments, the order in which the test image and the reference image are acquired can take place in any order. That is, in various embodiments, the test image can be acquired either before or after the reference image. The processes described herein can provide mapping coefficient regardless of the acquisition order or if the roles of the images are changed.

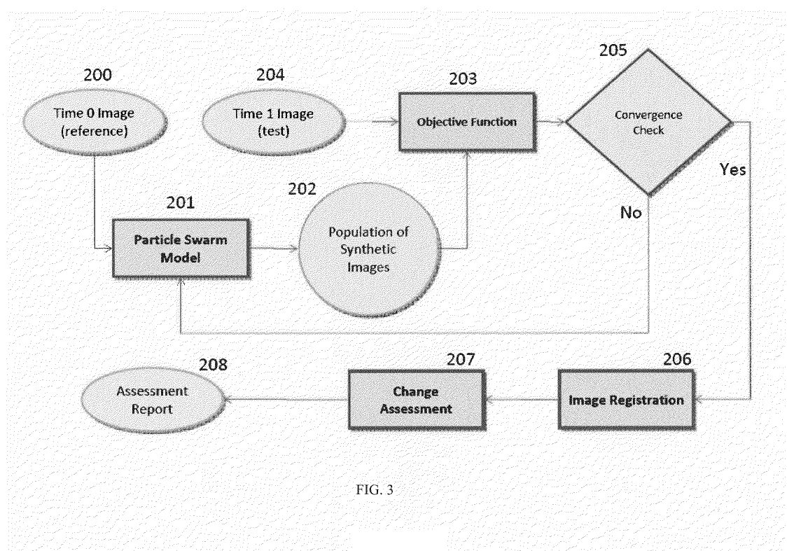

FIG. 3 shows an illustrative flowchart demonstrating how time sequence images can be overlaid in a particular embodiment. In the illustrated embodiment, the non-linear data processing algorithm is a particle swarm optimizer. In operation 200, a reference image is acquired at a first time. A particle swarm model can be applied in operation 201 in order to generate a population of synthetic images in operation 202 that provides objective function information 203, which can later be used in analyzing a test image. This operation can provide an initial topography assessment of the state space. At a second time after acquisition of the reference image, a test image is acquired in operation 204. Using linear parameters and non-linear parameters for each inclusion in the test image, along with objective function information 203, a convergence check 205 is applied to test the goodness of fit of the inclusion overlay in the test image and the reference image. The comparison between images can take place over the entire image or between sub-image sectors within the entire image. Objective function information 203 can include differential entropy between the test image (or sector) and a reference image (or sector). If the overlay has not converged to a desired degree, the particle swarm model can be applied again, and the convergence check repeated. The parameters of the inclusions in the test image become part of the objective function information 203 that is used in further assessing the goodness of fit for each inclusion. Thus, as more and more iterations are performed, there is more objective function information 203 upon which to base the overlay. After the overlay has converged to a desired degree, the overlay of the inclusions in the test image and the reference image are finalized in operation 206. Operation 206 can involve a deformation of sectors containing the inclusions in the reference image using a geometric transformation (e.g., an Affine transformation or a Perspective transformation) in some embodiments. Thereafter, changes in the inclusions between the test image and the reference image can be assessed in operation 207, and an output illustrating the differences for each inclusion can be produced in operation 208. In some embodiments all the inclusions are illustrated in the output. In other embodiments, the output can be filtered such that only inclusions having selected physical attributes (e.g., size, color and/or aspect ration) are indicated as being changed between the test image and the reference image.

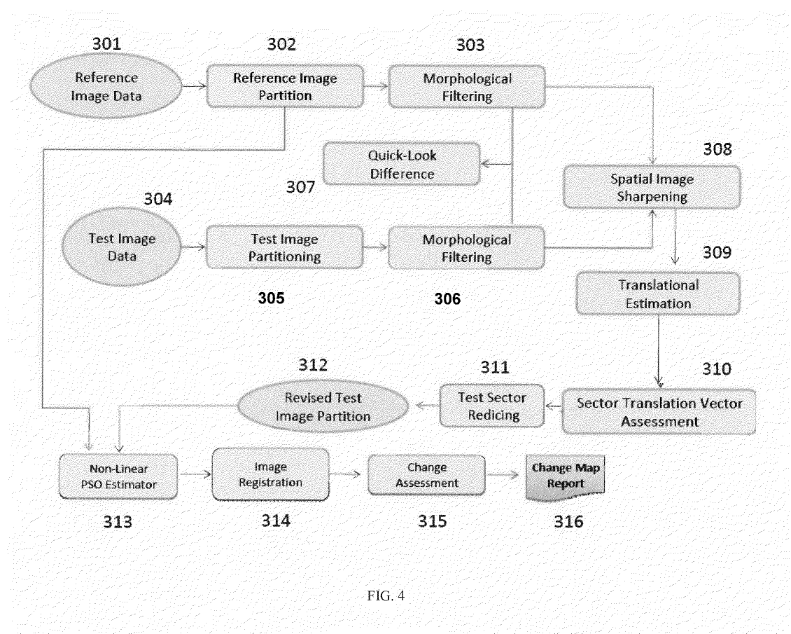

FIG. 4 shows an illustrative flowchart demonstrating how time sequence images can be overlaid in another particular embodiment. As shown in FIG. 3, reference image data and test image data can be collected in operations 301 and 304, respectively, and partitioned into sectors in operations 302 and 305. Morphological filtering of the images can then take place in operations 303 and 306, which can remove background clutter from the images. Thereafter, a “quick-look” difference of the reference image and the test image can be performed in operation 307. Spatial image sharpening of the test image and the reference image can be performed in operation 308. Processing of linear image parameters can then be used to produce a translational estimation for each sector of the image overlay in operation 309. Subsequently, a sector translation vector assessment can be generated for each sector in operation 310, followed by test sector redicing of the original test image in operation 311. Based upon the estimated translational differences, a revised test image partition can be generated in operation 312. Any of the foregoing operations can be performed iteratively in order to achieve a desired degree of convergence for the translational overlay of the test image and the reference image.

After a satisfactory overlay has been achieved by processing translational parameters, a particle swarm optimizer can be used in operation 313 to further refine the positions of the inclusions within the various sectors. Thereafter, the test image and the reference image can be registered in operation 314 and a change assessment in the images can be performed in operation 315. Again, any of the operations for processing the non-linear parameters can also be processed iteratively to achieve a desired degree of convergence. An output can be produced in the form of a change map output in operation 316.

As a non-limiting example FIGS. 5A-5D show an illustrative series of images before and after alignment using the present image analysis systems and methods, and the corresponding difference images produced in each case. FIGS. 5A and 5B show illustrative test and reference images of a mole inclusion before and after alignment, respectively. FIG. 5C shows an illustrative difference image of the misaligned images in FIG. 5A. FIG. 5D shows an illustrative difference image of the aligned images in FIG. 5B. When misaligned, the difference image of FIG. 5C might be interpreted by the image analysis system as a significant change. However, when aligned, the difference image of FIG. 5D might not be interpreted by the image analysis system as a significant change. In this regard, the difference image of FIG. 5C could represent a false positive result that would need further analysis by a physician. By performing a more accurate overlay, the present image analysis systems and methods can lessen the number of false positive results needing further clinical analysis.

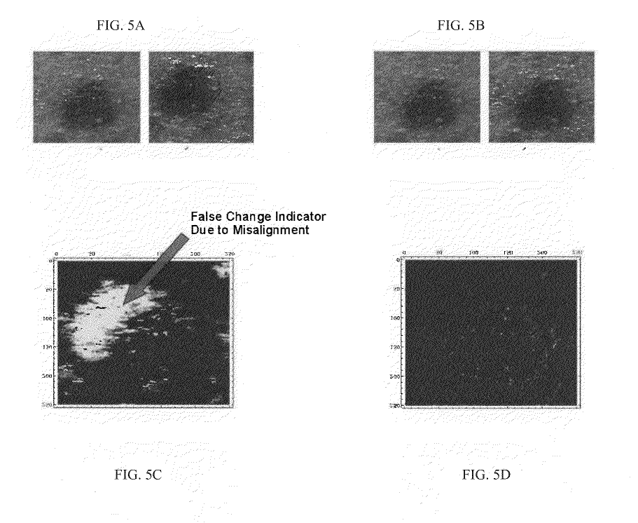

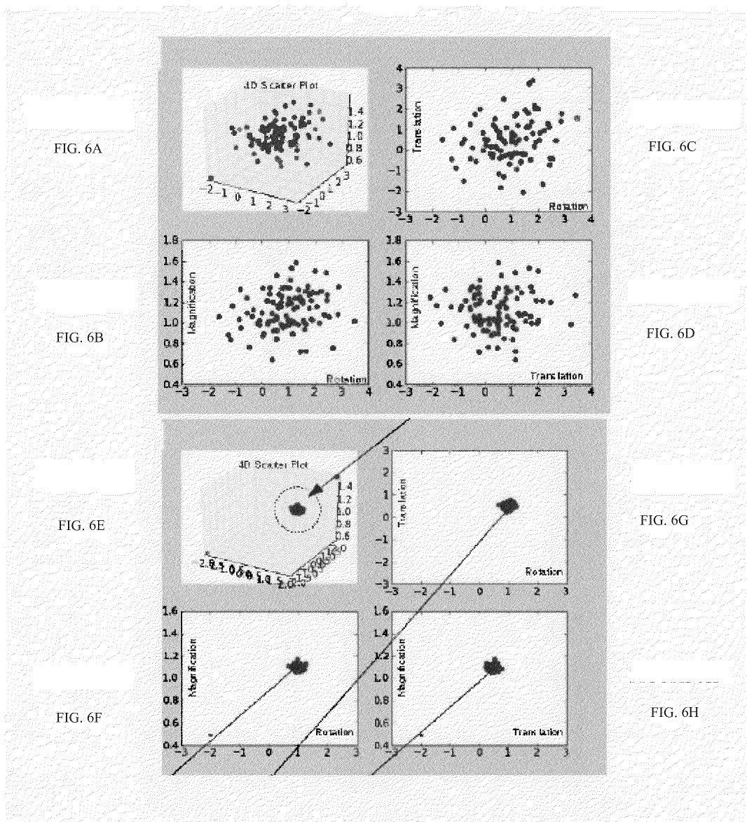

FIG. 6A shows an illustrative 4D scatter plot of mapping coefficients for four parameters (translation, rotation, magnification and background color) before processing with a particle swarm optimizer. FIGS. 6B-6D show illustrative 2D scatter plots of rotation, magnification and translation parameters before processing with a particle swarm optimizer. FIGS. 6E-6H show illustrative plots corresponding to those of FIGS. 6A-6D illustrating the convergence of mapping coefficients after processing with the particle swarm optimizer.

Various image collection devices can be used in association with the present image analysis systems and methods. In some embodiments, the image collection device can acquire a visual image such as a photograph. For example, in some embodiments, the image collection device can be a camera. In other embodiments, image collection devices other than visual image collection devices can be used. For example, in some embodiments, confocal microscopes, magnetic imaging devices (e.g. MRI) hyperspectral imaging devices, multispectral imaging devices, thermal sensing devices, polarimetric sensing devices, radiometric sensing devices, and any other like sensing device can be used. That is, the present image analysis systems and methods are not limited to the analysis of inclusions contained within visual images. In some embodiments, more than one image collection device can be used in overlaying the inclusions in the test image with those in the reference image. For example, in a non-limiting embodiment, a combination of a visual image and a thermal image might be used to produce a more accurate overlay. Specifically, in this regard, the visual image might not be significantly changed between a test image and a reference image, but a thermal property of the inclusion might be altered between the two. Other combinations of visual and non-visual imaging techniques or between various non-visual imaging techniques are also envisioned and within the scope of this invention.

In some embodiments, the present image analysis systems and methods can produce an output via at least one data output device. Suitable data output devices can include, for example, computer monitors, printers, electronic storage devices and the like. In some embodiments, the image processing device can produce a difference image at the data output device that highlights any significant changes between the test image and the reference image for any of the inclusions therein.

In addition to image differencing, other comparisons between a test image and a reference image can be performed to analyze changes between them. Image differencing is a scalar quantity. Vector quantities can be utilized in image comparison as well. For example, morphological changes in a test image can be represented in the form of a state vector where elements of the state vector correspond to changes in inclusion size, color, geometry and border characteristics. This information can then be presented to a user of the present systems in the form of a Geographical Information System (GIS) where two-dimensional image planes represent the magnitude of each vector component.

In some embodiments, the image processing devices described herein can contain a computer. In some embodiments, the image processing devices can utilize a graphical processing unit. Such graphical processing units can be part of a computer or they can be a standalone module, if desired. Computers and graphical processing units can utilize any of the previously described computer hardware, software, or other like processing components known in the art.

In some embodiments, image analysis systems described herein include at least one image collection device, an image processing device operating a particle swarm optimizer, and at least one data output device. The image processing device is operable to overlay a test image and a reference image upon one another and perform a comparison therebetween by processing both linear parameters and non-linear parameters, where each image contains a plurality of inclusions. In some embodiments, the test image and the reference image can be subdivided into a plurality of sectors, where each sector contains at least one inclusion. In some embodiments, the test image and/or reference image can be sharpened prior to overlayment.

In some embodiments, methods for overlaying and analyzing images containing a plurality of inclusions are described herein. In some embodiments, methods described herein include acquiring a reference image containing a plurality of inclusions, acquiring a test image containing the plurality of inclusions, overlaying the plurality of inclusions in the test image upon the plurality of inclusions in the reference image by using a non-linear data processing algorithm, and producing an output that illustrates any differences for each inclusion between the test image and the reference image after overlaying takes place. In some embodiments, the plurality of inclusions can be located on a deformable surface. In other embodiments, the plurality of inclusions can be located on a rigid surface.

In some embodiments, the methods can further include performing a coarse alignment of the plurality of inclusions in the test image upon the plurality of inclusions in the reference image, prior to using the non-linear data processing algorithm. In some embodiments, performing a coarse alignment can be further facilitated by positioning the at least one image collection device and the area being imaged into a standard orientation. For example, a patient being imaged may be requested to stand or sit in a specified orientation from image to image. By employing a standard orientation of the image collection device(s) and the area being imaged, it can be possible to orient the plurality of inclusions in the test image as close as possible to their “correct” positions by minimizing translational-type errors and image processing device alignment-type errors. In some embodiments, the test image and/or the reference image can be sharpened prior to overlaying the images.

In some embodiments, the present methods can involve dividing the reference image into a plurality of sectors. By performing this operation, the optimal orientation parameters for the image collection device(s) can be determined for each reference sector prior to the analysis of a corresponding sector in the test image. Thus, the local topography about each inclusion in the test image can be initially assessed prior to application of the non-linear data processing algorithm for analyzing the test image. In some embodiments, the sectors can be uniform in size. In some embodiments, the sectors can be variable in size. In some embodiments, each sector can contain at least one inclusion. In some embodiments, the sectors are small relative to the overall image space, such that they are substantially rigid on a local basis about each inclusion. Thus, by having small sectors, rigid body alignment techniques can be applied on a local basis for each inclusion in a test image.

In some embodiments, the present methods can further include analyzing the reference image using linear parameters to determine an initial topography solution for the test image. As noted above, determination of an initial topography solution for the test image can enhance the convergence rate of the non-linear data processing algorithm.

In some embodiments, the present methods can further include determining mapping coefficients for the inclusions in the test image and/or the reference image. In some embodiments, the linear parameters can be processed before the non-linear parameters. In some embodiments, only the non-linear parameters are processed using the non-linear data processing algorithm. In some embodiments, an initial optimization of the linear parameters can be fed into the non-linear data processing algorithm and processed with the non-linear parameters. In some embodiments, both linear parameters and non-linear parameters can be used to overlay the sectors in the test image upon the corresponding sector in the reference image.

In some embodiments, overlaying can be performed iteratively until a desired degree of convergence is reached. In some embodiments, overlaying can be performed iteratively until a fixed number of cycles have been conducted. In some embodiments, a desired degree of convergence can be based upon a rate or amount of change of the mapping coefficients estimated in successive iterations. In some embodiments, the desired degree of convergence can be based up a minimization of an objective function for the plurality of sectors within a test image, or a difference thereof between successive iterations. In some embodiments, the desired degree of convergence can be based upon minimization of an objective function obtained from a difference image generated after overlaying the test image and the reference image.

In some embodiments, after overlaying using the non-linear data processing algorithm, the present methods can further include deforming each sector of the test image onto a corresponding sector of the reference image. In some embodiments, each sector can be deformed using an Affine transformation or a Perspective transformation.

In some embodiments, the output of the present methods can be filtered. In some embodiments, the output can be filtered such that only inclusions having selected physical attributes are indicated as being changed between the test image and the reference image.

For additional details concerning the present embodiments, a prepublication manuscript is included herewith as Appendix I of the disclosure.

It is understood that modifications which do not substantially affect the activity of the various embodiments of this invention are also included within the definition of the invention provided herein. Although the invention has been described with reference to the disclosed embodiments, one having ordinary skill in the art will readily appreciate that these embodiments are only illustrative of the invention. It should be understood that various modifications can be made without departing from the spirit of the invention. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. While compositions and methods are described in terms of “comprising,” “containing,” or “including” various components or steps, the compositions and methods can also “consist essentially of” or “consist of” the various components and operations. All numbers and ranges disclosed above can vary by some amount. Whenever a numerical range with a lower limit and an upper limit is disclosed, any number and any subrange falling within the broader range is specifically disclosed. Also, the terms in the claims have their plain, ordinary meaning unless otherwise explicitly and clearly defined by the patentee. If there is any conflict in the usages of a word or term in this specification and one or more patent or other documents that may be incorporated herein by reference, the definitions that are consistent with this specification should be adopted.

What is claimed is:

1. An image analysis system comprising:
at least one image collection device;
an image processing device operable to
overlay a test image and a reference image upon one another and perform a comparison therebetween; and
sharpen at least one of the test image and the reference image; and
at least one data output device for outputting data related to the comparison of the test image and the reference image.

2. The image analysis system of claim 1, wherein the image processing device operates a non-linear data processing algorithm.

3. The image analysis system of claim 1, wherein the image processing device operates a non-linear data processing algorithm, the image analysis being selected from the group including a particle swarm optimizer, a neural network, a genetic algorithm, and any combination thereof.

4. The image analysis system of claim 1, wherein the image processing device processes both linear parameters and non-linear parameters in overlaying the test image and the reference image.

5. The image analysis system of claim 4, wherein the linear parameters and the nonlinear parameters are selected from the group consisting of x-translation relative to the reference image, y-translation relative to the reference image, image rotation relative to the reference image, shear of the at least one image collection device, image magnification relative to the reference image, image tone relative to the reference image, image gain relative to the reference image, and any combination thereof.

6. The image analysis system of claim 4, wherein each image contains a plurality of inclusions and the image processing device is operable for subdividing each image into a plurality of sectors and determining a set of mapping coefficients for each of the plurality of sectors.

7. The image analysis system of claim 6, wherein the image processing device is operable to iteratively minimize an objective function for each of the plurality of sectors within the test image;
wherein the objective function is selected from the group consisting of image entropy, hamming distance, gray level per band, and any combination thereof.

8. The image analysis system of claim 6, wherein the image processing device is operable to deform each sector in the test image onto a corresponding sector in the reference image after determining the set of mapping coefficients.

9. The image analysis system of claim 8, wherein each sector is deformed using an Affine transformation.

10. The image analysis system of claim 8, wherein each sector is deformed using a Perspective transformation.

11. The image analysis system of claim 6, wherein the image processing device processes the linear parameters prior to processing the non-linear parameters.

12. The image analysis system of claim 11, wherein processing of the linear parameters provides an estimated set of mapping coefficients for each sector, prior to processing of the non-linear parameters by the non-linear data processing algorithm.

13. The image analysis system of claim 1, the image processing device includes a microprocessor.

14. The image analysis system of claim 1, wherein the at least one image collection device comprises a camera.

15. The image analysis system of claim 1, wherein the at least one image collection device is selected from the group consisting of a camera, a confocal microscope, a magnetic sensing device, a hyperspectral sensing device, a multispectral sensing device, a thermal sensing device, a polarimetric sensing device, a radiometric sensing device, and any combination thereof.

16. A method comprising:
acquiring a reference image containing a plurality of inclusions;
after acquiring the reference image, acquiring a test image containing at least some of the plurality of inclusions;
sharpening at least one of the reference image and the test image;
overlaying the test image upon the reference image by using a non-linear data processing algorithm; and
producing an output that illustrates any differences between the test image and the reference image after overlaying takes place.

17. The method of claim 16, wherein the non-linear data processing algorithm is selected from the group consisting of a particle swarm optimizer, a neural network, a genetic algorithm, and any combination thereof.

18. The method of claim 16, wherein the non-linear data processing algorithm comprises a particle swarm optimizer.

19. The method of claim 16, wherein the plurality of inclusions are located on a deformable surface.

20. The method of claim 16, further comprising prior to using the non-linear data processing algorithm, dividing the reference image and the test image into a plurality of sectors.

21. The method of claim 20, further comprising prior to using the non-linear data processing algorithm, performing a coarse alignment of the sectors in the test image upon the corresponding sectors in the reference image.

22. The method of claim 21, wherein both linear parameters and non-linear parameters are used to overlay the sectors in the test image upon the corresponding sectors in the reference image.

23. The method of claim 22, wherein the linear parameters are processed prior to the non-linear parameters.

24. The method of claim 23, wherein only the non-linear parameters are processed using the non-linear data processing algorithm.

25. The method of claim 24, wherein the linear parameters and the non-linear parameters selected from the group consisting of x-translation relative to the reference image, y-translation relative to the reference image, image rotation relative to the reference image, shear of the image collection device, image magnification relative to the reference image, image tone relative to the reference image, image gain relative to the reference image, and any combination thereof.

26. The method of claim 25, further comprising determining a set of mapping coefficients for each of the plurality of sectors in the test image.

27. The method of claim 26, wherein overlaying is performed iteratively until a desired degree of convergence is reached.

28. The method of claim 27, wherein the desired degree of convergence is based upon a minimization of an objective function for each of the plurality of sectors within the test image;
wherein the objective function is selected from the group consisting of image entropy, hamming distance, gray level per band, and any combination thereof.

29. The method of claim 26, wherein overlaying is performed iteratively for a fixed number of cycles.

30. The method of claim 20, further comprising:
after overlaying using the non-linear data processing algorithm, deforming each sector in the test image onto a corresponding sector in the reference image.

31. A machine-readable medium providing instructions that, when executed by a machine, cause the machine to perform operations comprising:
acquiring a reference image containing a plurality of inclusions;
acquiring a test image containing at least some of the plurality of inclusions;
sharpening at least one of the reference image and the test image;
overlaying the test image and the reference image by using a non-linear data processing algorithm; and
producing an output that illustrates any differences between the test image and the reference image after overlaying takes place.

32. The machine-readable medium of claim 31, wherein overlaying the test image and the reference image by using a non-linear data processing algorithm includes use of a particle swarm optimizer.

33. The machine-readable medium of claim 32, wherein overlaying the test image and the reference image by using a non-linear data processing algorithm includes use of a neural network, a genetic algorithm, and any combination thereof.

34. The machine-readable medium of claim 33, wherein overlaying the test image and the reference image by using a non-linear data processing algorithm includes use of a genetic algorithm.

35. The machine-readable medium of claim 32, wherein overlaying the test image and the reference image by using a non-linear data processing algorithm includes use of a genetic algorithm.
